(19) United States
(12) Patent Application Publication
(10) Pub. No.: US 2026/0270758 A1
(43) Pub. Date: Sep. 10, 2026

(54) SCHEDULING FOR HIGH-THROUGHPUT MLO CAPABLE DEVICE

(71) Applicant: HEWLETT PACKARD ENTERPRISE DEVELOPMENT LP, Spring, TX (US)

(72) Inventors: Mohd Shahnawaz Siraj, San Jose, CA (US); Andre Beaudin, Montreal (CA); Omar El Ferkouss, St. Laurent (CA); Jianpo Han, Beijing (CN)

(21) Appl. No.: 19/075,485

(22) Filed: Mar. 10, 2025

(51) Int. Cl. H04W 28/02; H04W 76/15; H04W 84/12

(52) U.S. Cl. CPC H04W 28/0236; H04W 76/15; H04W 84/12

(57) ABSTRACT

The present disclosure proposes an intelligent scheduling method and system for high-throughput use cases in Wi-Fi 7 Multi-Link Operation (MLO) capable devices. The disclosure schedules and prioritizes Multi-Link Multi-Radio Simultaneous Transmission Reception (MLMR-STR) capable devices and focuses on dynamic channel allocation and load balancing for Access Points (APs). Therefore, through the combination of dynamic channel and bandwidth allocation and load balancing in a network system to address specific high throughput use-cases for Wi-Fi 7 capable MLMR-STR devices, the disclosure takes a holistic approach based on network conditions and client capabilities to optimize throughput of the network system.

### BACKGROUND

The primary feature of the Wi-Fi 7 standard is Multi-Link Operation (MLO), which promises high throughput and low latency. Wi-Fi 7 with the MLO technology can aggregate multiple channels on different frequency bands at the same time, which can negotiate seamless network traffic even if there is interference or congestion.

### BRIEF DESCRIPTION OF THE DRAWINGS

Implementations of the present disclosure may be understood from the following Detailed Description when read with the accompanying figures. In accordance with the standard practice in the industry, various features are not drawn to scale. In fact, the dimensions of the various features may be arbitrarily increased or reduced for clarity of discussion. Some examples of the present disclosure are described with reference to the following figures.

FIG. 1 illustrates an example network environment in which example implementations of the present disclosure may be implemented;

FIG. 2 illustrates an overall architecture according to multiple embodiments of the present disclosure;

FIG. 3 illustrates a flow chart of a method for intelligent scheduling for high-throughput MLO capable devices according to multiple embodiments of the present disclosure;

FIG. 4 illustrates a flow chart of a method for allocating clients of the network for APs according to multiple embodiments of the present disclosure

FIG. 5 illustrates an overall flow chart of a method for intelligent scheduling for high-throughput MLO capable devices according to multiple embodiments of the present disclosure; and

FIG. 6 illustrates an example electronic device according to implementations of the present disclosure.

### DETAILED DESCRIPTION

As mentioned above, the primary feature of the Wi-Fi 7 standard is MLO. However, the potential of MLO is somewhat limited due to the assumption that most client devices would prioritize power-saving features and support MLO in enhanced Multi-Link Single-Radio (e-MLSR) or Multi-Link Single Radio (MLSR) modes. Additionally, it is speculated that client devices would only support MLO on the 2.4+5 or 2.4+6 GHz bands. Generally, MLSR uses a single radio that can switch between different frequency bands or channels, but not simultaneously. The mode of MLSR provides performance gains by avoiding interference. And, e-MLSR is an advanced version of MLSR where a device can listen on multiple links but can transmit only on a single link. Mobile client devices are expected to implement the mode of e-MLSR to avoid the cost and complexity of multiple radio hardware. This allows MLMR capable access point (AP) devices to transmit to client devices on any of the bands.

The presence of 2.4 GHz band within an MLO group diminishes potential gains due to the interference found in the 2.4 GHz band. Even when conditions favor the 2.4 GHz link in certain instances, it might be better to wait and transmit over the 5 or 6 GHz bands. This is because the availability of Transmit Opportunity (TXOP) and Signal to Noise Ratio (SNR) could be higher, which would allow devices to transmit more data at faster speeds. Considering that client devices may only be able to use one link at a time for transmission and reception, transmitting over the higher frequency bands could be more efficient. Client devices do not have to support the 2.4 GHz band due to backward compatibility requirements.

However, recent developments have highlighted scenarios where power-saving considerations for client devices are secondary to the need for high throughput, e.g. airplanes, ships, and vehicles, where there is a significant demand for uploading or downloading large volumes of data when these devices are parked or docked in a small amount of time. In these cases, devices should have MLO capabilities to support MLMR-STR. This can also be used for wired AR/VR use cases, where power saving may not be an issue.

Therefore, the present disclosure relates to a smart scheduling algorithm for high throughput use cases in devices with Wi-Fi 7 MLO capabilities. Furthermore, the present disclosure relates to MLOs and different MLO operating modes. One of the main features of the IEEE 802.11 be (Wi-Fi-7) standard is MLO, which allows a device to use multiple Wi-Fi bands and channels over a single connection or link. This feature improves performance and reduces latency. Furthermore, the present disclosure provides an intelligent scheduling method and system for high-throughput use cases in Wi-Fi 7 MLO capable devices. The present disclosure schedules and prioritizes Multi-Link Multi-Radio Simultaneous Transmission Reception (MLMR-STR) capable devices and focuses on dynamic channel allocation and load balancing for Access Points (APs). Generally, Multi-Link Multi Radio (MLMR) uses multiple radios, and allows a device to communicate over different frequency bands or channels simultaneously. MLMR is ideal for high-demand applications. MLMR-STR allows devices to transmit and receive data simultaneously on multiple radios and channels. And the mode of MLMR-STR provides high throughput and is ideal for capacity demanding applications.

Furthermore, the method receives a connection notification from an AP of a network, wherein the connection notification indicates that at least one client supporting Multi-Link Multi-Radio Simultaneous Transmission Reception (MLMR-STR) capability is connected to the AP. And the method determines a current utilization of channels of the network. And, the method determines a traffic load across APs of the network. And, the method further allocates, based on the channel utilization and the traffic load, channels, and bandwidths of the network for APs to reduce an interference between the channels of the network. And, the method further distributes, based on the allocated channels and bandwidths of the network for the APs, a plurality of clients across the APs to allow the at least one client supporting the MLMR-STR capability to transmit simultaneously on multiple channels of the network.

Furthermore, through the combination of dynamic channel and bandwidth allocation and load balancing in a network system to address specific high throughput use-cases for Wi-Fi 7 capable MLMR-STR devices, the method takes a holistic approach based on network conditions and client capabilities to optimize throughput of the network system.

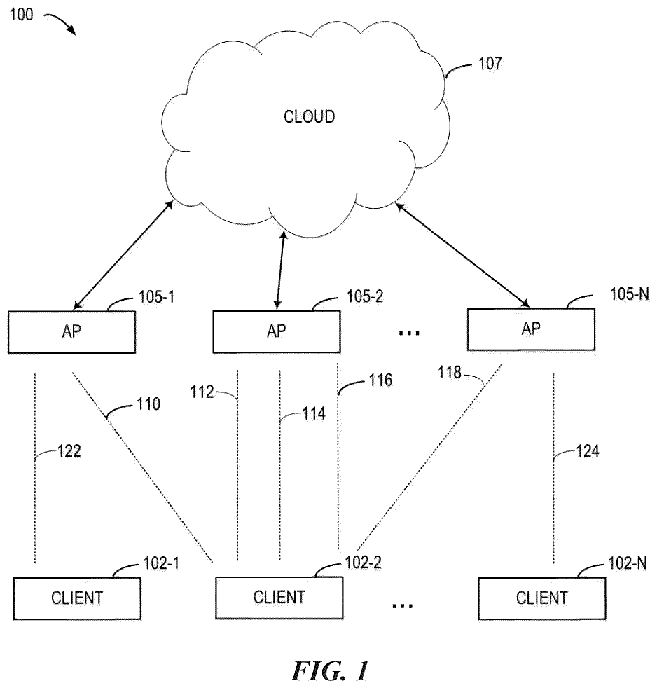

The advantages of implementations of the present disclosure will be described with reference to example implementations as described below. Reference is made below to FIG. 1 through FIG. 6 to illustrate basic principles and several example implementations of the present disclosure herein.

Reference is made to FIG. 1, which illustrates an example network environment 100 in which example implementations of the present disclosure may be implemented. As shown in FIG. 1, the network environment 100 may comprise clients 102-1, 102-2 and 102-N, APs 105-1, 105-2 and 105-N, and cloud network 107. It should be noted that the clients and APs shown in FIG. 1 are merely examples, and the network environment 100 may include multiple clients and APs, and it is not limited to the number shown in FIG. 1. Any of the APs 105-1, 105-2 and 105-N may operate on the 2.4 GHz band. The AP 105-2 may further operate on the 5 GHz band. The AP 105-2 may further operate on the 6 GHz band. The clients 102-1, 102-2, and 102-N may operate on the 2.4 GHz band. The client 102-2 may further operate on the 5 GHz band and the 6 GHz band as well as the AP 105-2. The AP 105-1, 105-2, and 105-N may be connected to the cloud network 107 through channels, and the cloud network 107 may communicate with the clients 102-1, 102-2, and 102-N through the APs 105-1, 105-2 and 105-N. It should be noted that the AP 105-2 and the client 102-1 supporting the MLMR-STR capability are merely examples. In the network environment 100, there may be more clients and APs supporting the MLMR-STR capability. On the other hand, some of the APs and some of the clients in the network environment 100 may not support the MLMR-STR capability.

The network environment 100 may further comprise one link, two links, or three links, etc. between each AP and the clients. For example, these links may include a link 110 between the AP 105-1 and the client 102-2 as shown in FIG. 1. The link 110 may operate on the 2.4 GHz frequency band.

For another example, these links may further include a link 112, a link 114, and a link 116 between the AP 105-N and the client 102-2 as shown in FIG. 1. The link 112 may operate on the 2.4 GHz frequency band. The link 114 may operate on the 5 GHz frequency band, and the link 116 may operate on the 6 GHz frequency band. For a further example, these links may further include a link 118 between the AP 108 and the client 102-2 as shown in FIG. 1. The link 118 may operate on the 5 GHz frequency band. For another further example, these links may further include a link 122 between the AP 105-1 and the client 102-1 as shown in FIG. 1. The link 122 may operate on the 2.4 GHz frequency band. For another example, these links may further include a link 124 between the AP 105-N and the client 102-N as shown in FIG. 1. The link 124 may operate on the 5 GHz frequency band.

Furthermore, it is to be understood that the number of APs, the number of clients, and the number of links are not limited to what they are shown in FIG. 1. The layout and arrangement of the clients and the APs are not limited to what they are shown in FIG. 1. It is to be understood that for the purposed of simplification, the term “link” and the term “band” may be used interchangeably throughout the present disclosure.

In the network environment 100, the client 102-2 may be a multi-link multi-radio device, which means it can receive or transmit frames via multiple links at the same time. The client 102-2 may also be a multi-link single radio (MLSR) device, which means it has multiple links, but it receives or transmits frames on a single link at a time.

The client 102-2 may assess the surrounding APs to choose an AP with the best channel quality, the most stable signals, the fastest speed, the best channel utility, or the like (can be collectively referred to as performance). For example, the client 102-2 may select the AP 105-2 as the best candidate AP to be connected to. The factors for assessing an AP in Wi-Fi 7 are more than in Wi-Fi 6 because there is more than one link that can be used for data transmission at a time. When the client 102-2 tries to find out the best candidate AP, all links should be considered. Moreover, because there are more links, which means more channels, the time for channel discovery should be more efficient for time-saving.

In some example implementations, the client 102-2 may obtain the basic link information of the neighbor APs, for example, the AP 105-1, the AP 105-2, and the AP MLD 105-N, from beacon/probe respond frames via a passive scanning process (for example, listening beacons or probe frames on the links) on all the links comprising the link 110, the link 112, the link 114, the link 116 and the link 118. Then, the client 102-2 may establish a candidate table. The candidate table may comprise each AP and its corresponding working channel/band information. For example, the AP 105-1 may have channel A on the link 110, the AP MLD 105-2 may have channel B on the link 112, the AP 105-2 may have channel C on the link 114, and the AP 105-2 may have channel D on the link 116. The AP 105-N may have channel E on the link 118. It is to be understood that there could be more channels on a link.

In some example implementations, the client 102-2 may create another candidate table for scanning. The other candidate table may comprise the link/band, its corresponding channels, and its corresponding AP MLDs. For example, the 2.4 GHz band (the link 112) may have channel A. The 5 GHz band (the link 114 and the link 118) may have channel C and channel E. The 6 GHz band (the link 116) may have channel D.

Then, the client 102-2 may obtain and verify complete information on all APs'Media Access Control (MAC)information and physical information via an active scanning process. The client 102-2 may send a multi-link (ML) probe request frame on the links to obtain and verify the whole ML information.

The client 102-2 may double-check the status of each link. The client 102-2 may need to scan the other links to cross-check if this link actually exists even though it may know this link information from a reduced neighbor report (RNR) and per-STA profile information from an ML probe. The client 102-2 may obtain RSSI information via a periodic scanning process on per-link for each of the AP 105-1, the AP 105-2, and the AP 105-N.

After obtaining the MAC information, the physical information, and the RSSI information on each active channel of the active links, the client 102-2 may compute a metric of each AP that considers the above factors as a whole. This metric may be called the path cost herein. Usually, the AP MLD with the smallest path cost may be selected as the best candidate AP MLD. In this way, the efficiency and accuracy of a client to evaluate the quality of neighbor APs can be improved. It is worth noting that the above is only a few examples of describing the mutual communication and interaction between the clients and the APs, which should not constitute any form of limitation to the present disclosure. Other clients and other APs also have similar mutual communication and interaction. To save space, it will not be repeated here.

On the other hand, the cloud network 107 may collect running information of the APs 105-1, 105-2, and 105-N, etc., and the clients 102-1, 102-2, and 102-N, etc. for central controlling. One or more embodiments of the present disclosure may intelligently schedule and prioritize MLMR-STR capable devices based on the collected running information of the APs 105-1, 105-2 and 105-N, etc., and the clients 102-1, 102-2, and 102-N, etc. And, One or more embodiments of the present disclosure may dynamically allocate channels and balance the load across the APs. Through the combination of dynamic channel and bandwidth allocation and load balancing in a network system to address specific high throughput use-cases for Wi-Fi 7 capable MLMR-STR devices, one or more embodiments of the present disclosure may take a holistic approach based on network conditions and client capabilities to optimize throughput of the network environment 100.

It is to be understood that in FIG. 1 and throughout the present disclosure, the number of any elements is only for the purpose of illustration without suggesting any limitations. The network environment 100 may comprise more or fewer links, and the APs and the clients may support more links as Wi-Fi technology develops in the future.

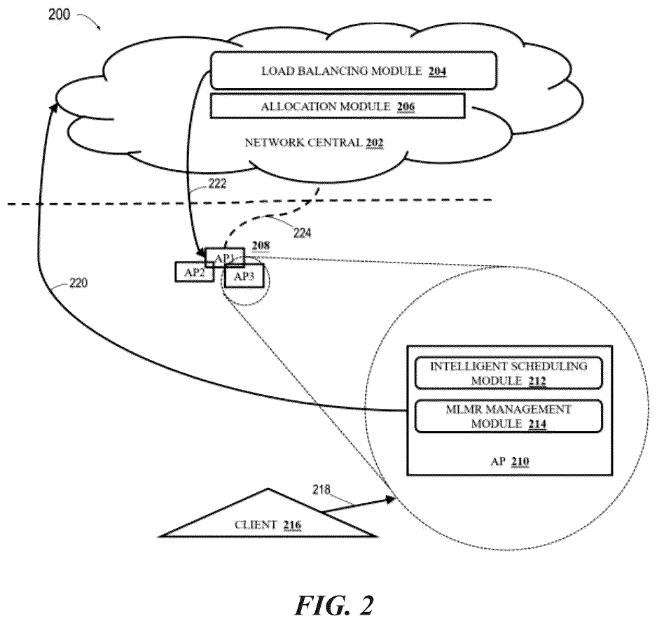

FIG. 2 shows an overall architecture 200 according to multiple embodiments of the present disclosure. In FIG. 2, the network environment 200 includes a network central 202, APs 208, and client(device) 216 etc. The network central 202 includes an allocation module 206 and a load balancing module 204. The APs 208 includes AP1, AP2 and AP3 etc. An AP 210 is shown as a magnified view of the AP3 structure, the AP 210 may be a Wi-Fi 7 AP. The AP 210 includes an intelligent scheduling module 212 and an MLMR management module 214. The AP 210 may support the MLMR-STR capability. The client 216 may also support the MLMR-STR capability.

In some embodiments, the network central 202 may be a cloud-managed network central. In some embodiments, the allocation module 206 may be an allocation module based on AirMatch algorithm to allocate the network resource for the APs and the clients. The AirMatch algorithm per se is an existing algorithm for load balancing, to save space, the specific algorithm will not be described here. In some embodiments, the allocation module 206 may enhance the Airmatch algorithm to dynamically allocate channels and bandwidth to APs based on connected devices based on current network conditions. The cloud services of the network central 202 get centralized notifications from all the APs when a device is connected. From these notifications, the network central 202 may learn which APs need to be configured with higher bandwidth. The network central 202 may also implement techniques to minimize interference on neighbor APs by switching channels or adjusting channel width in response to channel or bandwidth changes on some APs. This is to make sure that the APs serving high-capacity devices are configured with the highest possible bandwidth to meet the throughput needs.

In some embodiments, the AP 210 may include an intelligent scheduling module 212 and an MLMR management module 214. The intelligent scheduling module 212 may use scheduling algorithms to determine the order and priority of traffic flows of APs. And the MLMR management module 214 may manage the clients supporting the MLMR-STR capability.

In some embodiments, the client 216 supporting the MLMR-STR capability may connect (218) to the AP 210 which can also support the MLMR-STR capability. The AP 210 may report (220) the connection notification to the network central 202, wherein the connection notification indicates that at least one client supporting MLMR-STR capability is connected to the AP. The network central 202 may redistribute the clients across the APs 208, based on the allocation module 206 and a load balancing module 204. In some embodiments, the control information of the network central 202 may be sent to the APs 208 through the controlling channel 224. In some embodiments, the load balancing module 204 of the network central 202 may redistribute (222) clients, the clients may include the clients 102-1, 102-2 and 102-N, and the client 216, etc., across the APs 208.

It is to be understood that in FIG. 2 and throughout the present disclosure, the number of any elements is only for the purpose of illustration without suggesting any limitations. The overall architecture 200 may comprise more or fewer links, APs, and clients, and the APs and the clients may support more links as Wi-Fi technology develops in the future. And more APs and more clients may support MLMR-STR capability. Multiple implementations of the present disclosure will be described based on the overall architecture shown in FIG. 2.

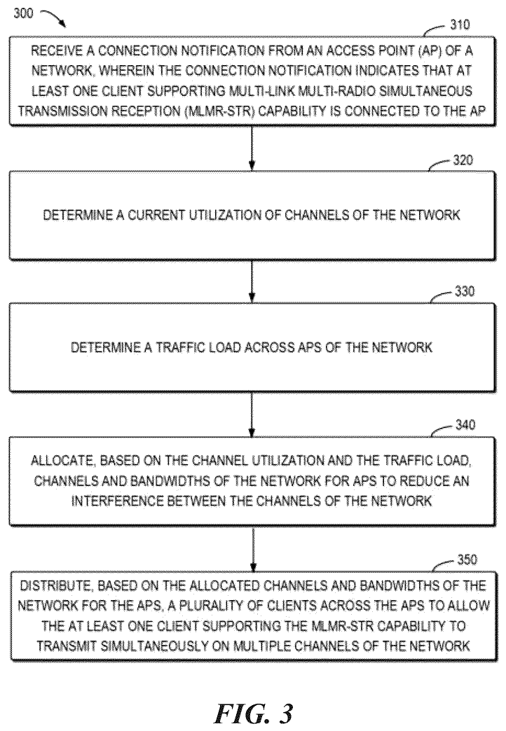

Now referring to FIG. 3, FIG. 3 shows a flow chart of a method 300 for intelligent scheduling for high-throughput MLO capable devices according to multiple embodiments of the present disclosure. At block 310, a connection notification from an Access Point (AP) of a network is received, wherein the connection notification indicates that at least one client supporting MLMR-STR capability is connected to the AP. In some embodiments, the client 216 supporting the MLMR-STR capability may connect to the AP 210 which can also support the MLMR-STR capability at 218. The AP 210 may report the connection notification to the network central 202 at 220, and the connection notification indicates that the client 216 supporting MLMR-STR capability is connected to the AP 210. The network central 202 may receive the connection notification.

At block 320, a current utilization of channels of the network is determined. And at block 330, determining a traffic load across APs of the network. In some embodiments, the method 300 may further include determining the current interference levels of the channels of the network. And, the method 300 may further include determining, based on the current utilization and the current interference levels, the current usage of the channels of the network.

At block 340, based on the channel utilization and the traffic load, channels, and bandwidths of the network for APs are allocated to reduce interference between the channels of the network. In some embodiments, based on the current usage of the channels of the network and the traffic load across APs of the network, the APs 208 of the network may be classified. And based on the classification of the APs, at least one AP 210 may be determined to support the at least one client 216, wherein the at least one AP 210 may also support the MLMR-STR capability. In some embodiments, a client using Single-Link Operation (SLO) or channel bandwidth less than a preset bandwidth threshold may be disallowed to connect to the at least one AP, wherein the preset bandwidth threshold may be 20 MHz.

In some embodiments, the network central 202 may get centralized notifications from all the APs when a client supporting MLMR-STR capability is connected. From these notifications, the system could learn which APs need to be configured with higher bandwidth. The network central 202 may also implement techniques to minimize interference on neighbor APs by switching channels or adjusting channel width in response to channel or bandwidth changes on some APs. This is to make sure that the APs serving high-capacity devices are configured with the highest possible bandwidth to meet the throughput needs.

Furthermore, in some embodiments, the method 300 may classify clients based on MLMR-STR capability and assume high throughput demands from these clients. The assumption is that only a specific device types should support MLMR-STR capability. Additionally, there can be some proprietary mechanisms to exchange very specific information in the form of vendor Information Equipment (IE), which may not be possible using standard mechanisms based on Wi-Fi Quality of Service (QoS) management features. Additionally, once the APs to serve the high-demand clients are identified, the method 300 may disallow low throughput clients that use SLO or lower channel bandwidth (e.g. 20 MHz clients).

Continue with reference to FIG. 3. At block 350, based on the allocated channels and bandwidths of the network for the APs, a plurality of clients across the APs may be distributed to allow the at least one client supporting the MLMR-STR capability to transmit simultaneously on multiple channels of the network. In some embodiments, the traffic load on the APs may be monitored. And, in response to an arrival of a new client supporting the MLMR-STR capability, the device distribution across the at least one AP may be adjusted.

Furthermore, the method 300 may also distribute devices across multiple APs to balance the load, preventing any single AP or channel from becoming a bottleneck. In some embodiments, the method 300 may employ IEEE 802.11v techniques now and Wi-Fi 7 R2 MLO specific standard mechanisms in the future to suggest alternate links.

In some embodiments, the method 300 may continuously monitor network load on each AP and dynamically adapt to new client arrival to adjust the device distribution across the available APs in time. In some embodiments, the method 300 may include monitoring performance of the network. And, in response to the performance not meeting Quality of Service (QoS), the method further includes re-evaluating the current usage of channels of the network, the traffic load across APs of the network, and the capabilities of the plurality of clients.

In some embodiments, the method 300 may include determining capabilities of the plurality of clients. And the method 300 may include determining requirements of applications running on the plurality of clients. And the method 300 may include performing, based on the capabilities of the APs and the requirements of applications running on the plurality of clients, load balancing for the APs. In some embodiments, the method 300 may include redistributing, based on the capabilities of the plurality of clients, the plurality of clients across the APs. And, the method 300 may further include prioritizing, based on the requirements of the applications, the applications. In some embodiments, the method 300 may include grouping, based on similar Quality of Service (QoS) requirements and similar traffic load, the plurality of clients. And, the method 300 may further include in response to the first application requiring more network resources than the second application, prioritizing the first application over the second application. Furthermore, the method 300 may include reserving a portion of network resources (e.g., specific Target Wake Time (TWT) slots) for critical applications to guarantee a desired bitrate.

In some embodiments, the method 300 may also provide prioritization and context aware scheduling by incorporating context-aware scheduling that considers the specific requirements of different applications and clients, grouping clients with similar QoS requirements and traffic load to balance the load and maximize Multi-User Multiple-Input Multiple-Output (MU-MIMO) gains and leveraging TXOP bursting and scheduling algorithms and assign higher priority to high demand applications.

In some embodiments, the method 300 may provide an MLMR management. the method 300 may include determining, based on the traffic load across APs of the network and capabilities of the at least one client, a combination of links for the at least one client. And the method 300 may include selecting, based on requirements of the at least one client, link Signal-to-Noise Ratio (SNR) and real-time interference levels on a link, a link for the at least one client. In some embodiment, the method 300 may include allowing, based on Transmission Identifier (TID)-to-link mapping in both directions, the APs and the at least one client to transmit simultaneously on multiple links.

Furthermore, the method 300 may provide simultaneous Transmission by leveraging TID-to-link mapping to allow devices to transmit simultaneously on multiple links. And, the method 300 may suggest 2 or 3 links (a combination of 2, 5, and 6 GHz) depending on the load and client devices'capabilities for the clients. And, the method 300 may suggest link selection based on a combination of metrics of device requirements, link SNR, and real-time interference levels on a link. This is in the case the AP cannot use MLMR-STR momentarily.

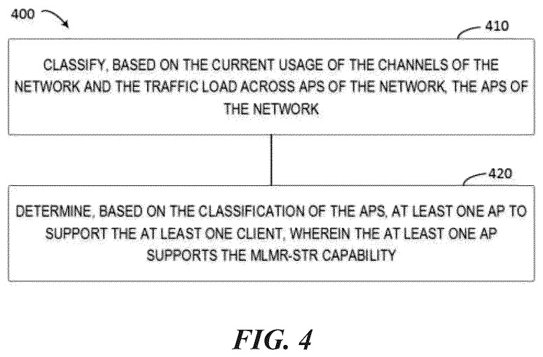

Now referring to FIG. 4, FIG. 4 shows a flow chart of a method 400 for allocating clients of the network for APs according to multiple embodiments of the present disclosure. At 410, based on current usage of the channels of the network and the traffic load across APs of the network, the APs of the network are classified. And, at 420, based on the classification of the APs, at least one AP may be determined to support the at least one client, wherein the at least one AP supports the MLMR-STR capability. In some embodiments, the method 400 may monitor the traffic load on the APs, and in response to an arrival of a new client supporting the MLMR-STR capability, the method 400 may further adjust the device distribution across the at least one AP.

In some embodiments, for example, at least one AP 210 may be determined to support the at least one client 216, wherein the at least one AP 210 may also support the MLMR-STR capability. In some embodiment, the method 400 may disallow a client using Single-Link Operation (SLO) or channel bandwidth less than a preset bandwidth threshold to connect to the at least one AP. Furthermore, in some embodiments, a client using SLO or channel bandwidth less than a preset bandwidth threshold may be disallowed to connect to the at least one AP, wherein the preset bandwidth threshold may be 20 MHz.

In some embodiments, the network central 202 may get centralized notifications from all the APs when a client supporting MLMR-STR capability is connected. From these notifications, the system could learn which APs need to be configured with higher bandwidth. The network central 202 may also implement techniques to minimize interference on neighbor APs by switching channels or adjusting channel width in response to channel or bandwidth changes on some APs. This is to make sure that the APs serving high-capacity devices are configured with highest possible bandwidth to meet the throughput needs.

Furthermore, in some embodiments, the method 400 may classify clients based on MLMR-STR capability and assume high throughput demands from these clients. The assumption is that only specific device types should support MLMR-STR capability. Additionally, there can be some proprietary mechanisms to exchange very specific information in the form of vendor Information Equipment (IE), which may not be possible using standard mechanisms based on Wi-Fi Quality of Service (QoS) management features. Additionally, once the APs to serve the high-demand clients are identified, the method 300 may disallow low throughput clients that use SLO or lower channel bandwidth (e.g. 20 MHz clients).

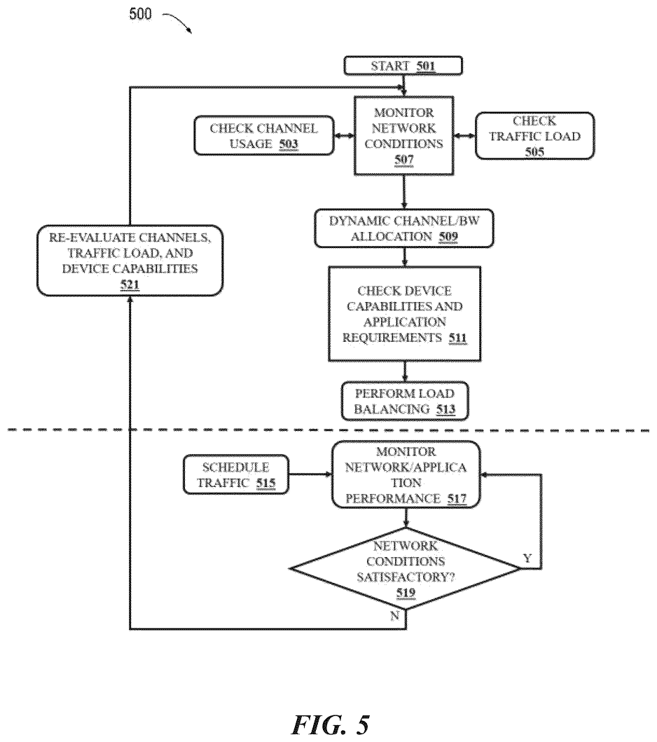

Now referring to FIG. 5, in order to help those skilled in the art to understand the present disclosure as a whole, FIG. 5 shows an overall flow chart of a method 500 for intelligent scheduling for high-throughput MLO capable devices according to multiple embodiments of the present disclosure. At 501, the method 500 is started. At 507, in response to receiving the notification of re-evaluate channels, traffic Load, and device capabilities of the network from the APs, the method 500 may monitor the network conditions by checking channel usage at block 503 or checking the traffic load of the network at 505. In some embodiments, checking the channel usage may include calculating the current utilization of the channels and interference levels of the APs. And, checking the traffic load may include calculating the traffic load across different APs.

In some embodiments, the method 500 may further include determining the current interference levels of the channels of the network. And, the method 500 may further include determining, based on the current utilization and the current interference levels, the current usage of the channels of the network.

At block 509, the channels of the network are dynamically allocated. In some embodiments, the channels and bandwidth of the network are dynamically allocated to minimize the interference between the APs and maximize performance of the whole network. In some embodiments, based on the current usage of the channels of the network and the traffic load across APs of the network, the APs of the network may be classified. And based on the classification of the APs, at least one AP may be determined to support the at least one client, wherein the at least one AP may also support the MLMR-STR capability. In some embodiments, a client using SLO or channel bandwidth less than a preset bandwidth threshold may be disallowed to connect to the at least one AP, wherein the preset bandwidth threshold may be 20 MHz.

In some embodiments, the network may get centralized notifications from all the APs when a client supporting MLMR-STR capability is connected. From these notifications, the system could learn which APs need to be configured with higher bandwidth. The network may also implement techniques to minimize interference on neighbor APs by switching channels or adjusting channel width in response to channel or bandwidth changes on some APs. This is to make sure that the APs serving high-capacity devices are configured with the highest possible bandwidth to meet the throughput needs.

Furthermore, in some embodiments, the method 500 may classify clients based on MLMR-STR capability and assume high throughput demands from these clients. The assumption is that only specific device types should support MLMR-STR capability. Additionally, there can be some proprietary mechanisms to exchange very specific information in the form of vendor Information Equipment, which may not be possible using standard mechanisms based on Wi-Fi QoS management features. Additionally, once the APs to serve the high-demand clients are identified, the method 500 may disallow low throughput clients that use SLO or lower channel bandwidth (e.g. 20 MHz clients).

In some embodiments, the traffic load on the APs may be monitored. And in response to an arrival of a new client supporting the MLMR-STR capability, the device distribution across the at least one AP may be adjusted. Furthermore, the method 500 may also distribute devices across multiple APs to balance the load, preventing any single AP or channel from becoming a bottleneck. In some embodiments, the method 500 may employ IEEE 802.11v techniques now and Wi-Fi 7 R2 MLO specific standard mechanisms in the future to suggest alternate links.

In some embodiments, the method 500 may continuously monitor network load on each AP and dynamically adapt to new client arrival to adjust the device distribution across the available APs in time. In some embodiments, the method 300 may include monitoring performance of the network. And, in response to the performance not meeting QoS, the method further includes re-evaluating the current usage of channels of the network, the traffic load across APs of the network, and the capabilities of the plurality of clients.

Continue with reference to FIG. 5. At block 511, device capabilities and application requirements may be checked. And at block 513, the method 500 may perform load balancing for the network by adjusting the traffic distribution and prioritizing the traffic based on device capabilities and application requirements. In some embodiments, the adjusting the traffic distribution may include redistributing the clients across the APs. And, the prioritizing the traffic may include prioritizing high-demand applications. The high-demand applications mean the applications need more network resource. In some embodiments, the traffic may be scheduled by using scheduling algorithms (e.g., Strict Priority Scheduling (SP),Weighted Fair Queuing (WFQ), Priority-based Weighted Round Robin (PWRR), etc.) to determine the order and priority of traffic flows.

In some embodiments, the method 500 may include determining capabilities of the plurality of clients. And, the method 500 may include determining requirements of applications running on the plurality of clients. And, the method 500 may include performing, based on the capabilities of the APs and the requirements of applications running on the plurality of clients, load balancing for the APs. In some embodiments, the method 500 may include redistributing, based on the capabilities of the plurality of clients, the plurality of clients across the APs. And, the method 500 may further include prioritizing, based on the requirements of the applications, the applications. In some embodiments, the method 500 may include grouping, based on similar QoS requirements and similar traffic load, the plurality of clients. And, the method 500 may further include in response to the first application requiring more network resources than the second application, prioritizing the first application over the second application. Furthermore, the method 500 may include reserving a portion of network resources (e.g., specific TWT slots) for critical applications to guarantee a desired bitrate.

Back referring to FIG. 5, at block 515, in some embodiments, the method 500 may also provide prioritization and context aware scheduling by incorporating context-aware scheduling that considers the specific requirements of different applications and clients, grouping clients with similar QoS requirements and traffic load to balance the load and maximize MU-MIMO gains and leveraging TXOP bursting and scheduling algorithms and assign higher priority to high demand applications.

At block 517, the network performance and the application performance may be monitored. And, the method 500 may continuously check if the network performance meets the desired QoS requirements at 519. If conditions are satisfactory (Y), continue monitoring at 517. If not (N), the method 500 may re-evaluate the channels, the traffic Load, and the client capabilities by sending a request of re-evaluating the channels, the traffic Load, and the client capabilities at 521.

In some embodiments, the method 500 may provide an MLMR management. the method 500 may include determining, based on the traffic load across APs of the network and capabilities of the at least one client, a combination of links for the at least one client. And, the method 500 may include selecting, based on requirements of the at least one client, link Signal-to-Noise Ratio (SNR) and real-time interference levels on a link, a link for the at least one client. In some embodiment, the method 500 may include allowing, based on Transmission Identifier (TID)-to-link mapping in both directions, the APs and the at least one client to transmit simultaneously on multiple links.

Furthermore, the method 500 may provide simultaneous Transmission by leveraging TID-to-link mapping to allow devices to transmit simultaneously on multiple links. And, the method 500 may suggest 2 or 3 links (combination of 2, 5, and 6 GHz) depending on the load and client devices' capabilities for the clients. And the method 500 may suggest link selection based on a combination of metrics of device requirements, link SNR, and real-time interference levels on a link. This is in the case the AP cannot use MLMR-STR momentarily.

In this way, through the combination of dynamic channel and bandwidth allocation and load balancing in a network system to address specific high throughput use-cases for Wi-Fi 7 capable MLMR-STR devices, the method 500 takes a holistic approach based on network conditions and client capabilities to optimize throughput of the network system.

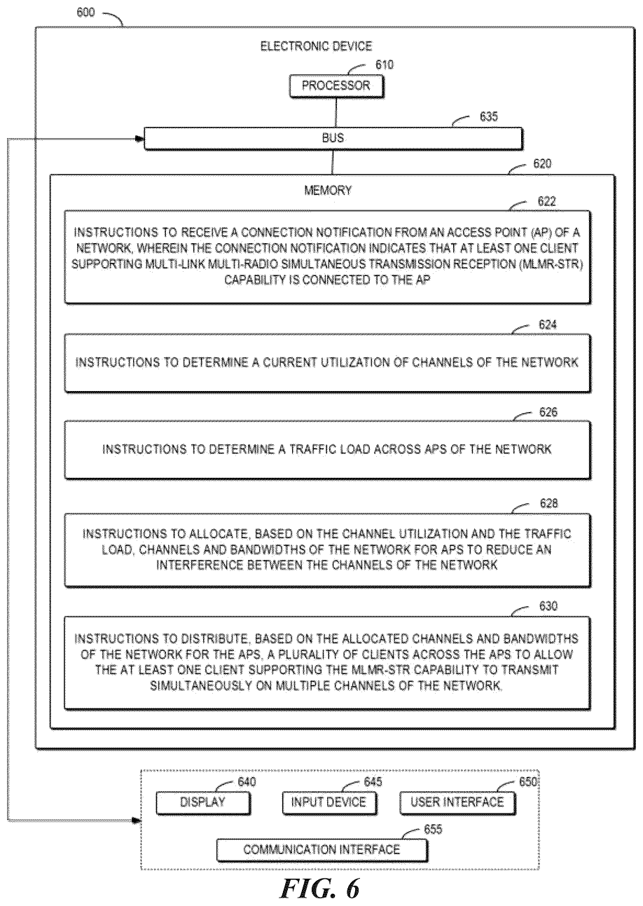

Reference is made to FIG. 6, which illustrates an example electronic device 600 according to implementations of the present disclosure. As shown in FIG. 6, the electronic device 600 comprises at least one processor 610, and a memory 620 coupled to the at least one processor 610 via a bus 735. The memory 620 stores instructions 622, 624, 626, 628 and 630 to cause the processor 610 to perform actions according to example implementations of the present disclosure. As shown in FIG. 6, the memory 620 stores instructions 622 to receive a connection notification from an AP of a network, wherein the connection notification indicates that at least one client supporting Multi-Link Multi-Radio Simultaneous Transmission Reception (MLMR-STR) capability is connected to the AP. The memory 620 further stores instructions 624 to determine a current utilization of channels of the network. The electronic device 600 may further comprise or be connected to a display 640, an input device 645, a user interface 650, and/or a communication interface 655.

The memory 620 further stores instructions 626 to determine a traffic load across APs of the network. The memory 620 further stores instructions 628 to allocate, based on the channel utilization and the traffic load, channels, and bandwidths of the network for APs to reduce an interference between the channels of the network. And, The memory 620 further stores instructions 630 to distribute, based on the allocated channels and bandwidths of the network for the APs, a plurality of clients across the APs to allow the at least one client supporting the MLMR-STR capability to transmit simultaneously on multiple channels of the network. The stored instructions and the functions that the instructions may perform can be understood with reference to the description of FIGS. 2-6. For the purpose of simplification, the details of instructions 622, 624, 626, 628, and 630 will not be discussed herein.

Similarly, by implementing the instructions 622, 624, 626, 628, and 630, through the combination of dynamic channel and bandwidth allocation and load balancing in a network system to address specific high throughput use-cases for Wi-Fi 7 capable MLMR-STR devices, electronic device 600 takes a holistic approach based on network conditions and client capabilities to optimize throughput of the network system. Other advantages of implementations will not be discussed again for the sake of simplification.

Program codes or instructions for carrying out methods of the present disclosure may be written in any combination of one or more programming languages. These program codes or instructions may be provided to a processor or controller of a general-purpose computer, special-purpose computer, or other programmable data processing apparatus, such that the program codes, when executed by the processor or controller, cause the functions/operations specified in the flowcharts and/or block diagrams to be implemented. The program code or instructions may execute entirely on a machine, partly on the machine, as a stand-alone software package, partly on the machine and partly on a remote machine, or entirely on the remote machine or server.

Program codes or instructions for carrying out methods of the present disclosure may be written in any combination of one or more programming languages. These program codes or instructions may be provided to a processor or controller of a general-purpose computer, special-purpose computer, or other programmable data processing apparatus, such that the program codes, when executed by the processor or controller, cause the functions/operations specified in the flowcharts and/or block diagrams to be implemented. The program code or instructions may execute entirely on a machine, partly on the machine, as a stand-alone software package, partly on the machine and partly on a remote machine, or entirely on the remote machine or server.

In the context of this disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may include but is not limited to an electronic, magnetic, optical, electromagnetic, infrared, or semiconductor system, apparatus, device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order or that all illustrated operations be performed to achieve desirable results. In certain circumstances, multitasking and parallel processing may be advantageous. Certain features that are described in the context of separate implementations may also be implemented in combination in a single implementation. Conversely, various features that are described in the context of a single implementation may also be implemented in multiple implementations separately or in any suitable sub-combination.

In the foregoing Detailed Description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

What is claimed is:

1. A method comprising:
receiving a connection notification from an Access Point (AP) of a network, wherein the connection notification indicates that at least one client supporting Multi-Link Multi-Radio Simultaneous Transmission Reception (MLMR-STR) capability is connected to the AP;
determining a current utilization of channels of the network;
determining a traffic load across APs of the network;
allocating, based on the channel utilization and the traffic load, channels, and bandwidths of the network for APs to reduce an interference between the channels of the network; and
distributing, based on the allocated channels and bandwidths of the network for the APs, a plurality of clients across the APs to allow the at least one client supporting the MLMR-STR capability to transmit simultaneously on multiple channels of the network.

2. The method of claim 1, further comprising:
determining current interference levels of the channels of the network; and
determining, based on the current utilization and the current interference levels, current usage of the channels of the network.

3. The method of claim 2, wherein allocating, based on the channel utilization and the traffic load, channels and bandwidths of the network for APs to reduce an interference between the channels of the network comprises:
classifying, based on the current usage of the channels of the network and the traffic load across APs of the network, the APs of the network; and
determining, based on the classification of the APs, at least one AP to support the at least one client, wherein the at least one AP supports the MLMR-STR capability.

4. The method of claim 3, wherein determining, based on the classification of the APs, at least one AP to support at least one client supporting MLMR-STR capability comprises:
disallowing a client using Single-Link Operation (SLO) or channel bandwidth less than a preset bandwidth threshold to connect to the at least one AP.

5. The method of claim 4, wherein distributing, based on the allocated channels and bandwidths of the network for the APs, a plurality of clients across the APs to allow the at least one client to transmit simultaneously on multiple channels of the network comprises:
monitoring the traffic load on the APs; and
in response to an arrival of a new client supporting the MLMR-STR capability, adjusting the device distribution across the at least one AP.

6. The method of claim 1, further comprising:
determining capabilities of the plurality of clients;
determining requirements of applications running on the plurality of clients; and
performing, based on the capabilities of the APs and the requirements of applications running on the plurality of clients, load balancing for the APs.

7. The method of claim 6, wherein performing, based on the capabilities of the APs and the requirements of applications running on the APs, load balancing for the APs comprises:
redistributing, based on the capabilities of the plurality of clients, the plurality of clients across the APs; and
prioritizing, based on the requirements of the applications, the applications.

8. The method of claim 7, wherein performing, based on the capabilities of the plurality of clients and the requirements of applications running on the APs, load balancing for the APs further comprises:
grouping, based on similar Quality of Service (QoS) requirements and similar traffic load, the plurality of clients; and
in response to the first application requiring more network resources than the second application, prioritizing the first application over the second application.

9. The method of claim 1, further comprising:
monitoring performance of the network;
in response to the performance not meeting Quality of Service (QoS), re-evaluating the current usage of channels of the network, the traffic load across APs of the network, and the capabilities of the plurality of clients.

10. The method of claim 1, further comprising at least one of the following:
determining, based on the traffic load across APs of the network and capabilities of the at least one client, a combination of links for the at least one client; or
selecting, based on requirements of the at least one client, link Signal-to-Noise Ratio (SNR) and real-time interference levels on a link, a link for the at least one client.

11. An electronic device comprising:
at least one processor; and
a memory coupled to the at least one processor, the memory storing instructions to cause the at least one processor to:
receive a connection notification from an Access Point (AP) of a network, wherein the connection notification indicates that at least one client supporting Multi-Link Multi-Radio Simultaneous Transmission Reception (MLMR-STR) capability is connected to the AP;
determine a current utilization of channels of the network;
determine a traffic load across APs of the network;
allocate, based on the channel utilization and the traffic load, channels, and bandwidths of the network for APs to reduce an interference between the channels of the network; and
distribute, based on the allocated channels and bandwidths of the network for the APs, a plurality of clients across the APs to allow the at least one client supporting the MLMR-STR capability to transmit simultaneously on multiple channels of the network.

12. The electronic device of claim 11, wherein the instructions further cause the at least one processor to:
determine current interference levels of the channels of the network; and
determine, based on the current utilization and the current interference levels, current usage of the channels of the network.

13. The electronic device of claim 12, wherein the instructions causing the at least one processor to allocate, based on the channel utilization and the traffic load, channels, and bandwidths of the network for APs to reduce an interference between the channels of the network further cause the at least one processor to:
classify, based on the current usage of the channels of the network and the traffic load across APs of the network, the APs of the network; and
determine, based on the classification of the APs, at least one AP to support the at least one client, wherein the at least one AP supports the MLMR-STR capability.

14. The electronic device of claim 13, wherein the instructions causing the at least one processor to determine, based on the classification of the APs, at least one AP to support at least one client supporting MLMR-STR capability further cause the at least one processor to:
disallow a client using Single-Link Operation (SLO) or channel bandwidth less than a preset bandwidth threshold to connect to the at least one AP.

15. The electronic device of claim 14, wherein the instructions causing the at least one processor to distribute, based on the allocated channels and bandwidths of the network for the APs, a plurality of clients across the APs to allow the at least one client to transmit simultaneously on multiple channels of the network further cause the at least one processor to:
monitor the traffic load on the APs; and
in response to an arrival of a new client supporting the MLMR-STR capability, adjust the device distribution across the at least one AP.

16. The electronic device of claim 11, wherein the instructions further cause the at least one processor to:
determine capabilities of the plurality of clients;
determine requirements of applications running on the plurality of clients; and
perform, based on the capabilities of the APs and the requirements of applications running on the plurality of clients, load balancing for the APs.

17. The electronic device of claim 16, wherein the instructions causing the at least one processor to perform, based on the capabilities of the APs and the requirements of applications running on the APs, load balancing for the APs further cause the at least one processor to:
redistribute, based on the capabilities of the plurality of clients, the plurality of clients across the APs; and
prioritize, based on the requirements of the applications, the applications.

18. The electronic device of claim 17, wherein the instructions causing the at least one processor to perform, based on the capabilities of the plurality of clients and the requirements of applications running on the APs, load balancing for the APs further cause the at least one processor to:
group, based on similar Quality of Service (QoS) requirements and similar traffic load, the plurality of clients; and
in response to the first application requiring more network resources than the second application, prioritize the first application over the second application.

19. The electronic device of claim 11, wherein the instructions further cause the at least one processor to:
monitor performance of the network;
in response to the performance not meeting Quality of Service (QoS), re-evaluate the current usage of channels of the network, the traffic load across APs of the network, and the capabilities of the plurality of clients.

20. A non-transitory computer-readable medium comprising instructions stored thereon which, when executed by an electronic device, cause the electronic device to:
receive a connection notification from an Access Point (AP) of a network, wherein the connection notification indicates that at least one client supporting Multi-Link Multi-Radio Simultaneous Transmission Reception (MLMR-STR) capability is connected to the AP;
determine a current utilization of channels of the network;
determine a traffic load across APs of the network;
allocate, based on the channel utilization and the traffic load, channels, and bandwidths of the network for APs to reduce an interference between the channels of the network; and
distribute, based on the allocated channels and bandwidths of the network for the APs, a plurality of clients across the APs to allow the at least one client supporting the MLMR-STR capability to transmit simultaneously on multiple channels of the network.
